(19) United States
(12) Patent Application Publication
(10) Pub. No.: US 2026/0211817 A1
(43) Pub. Date: Jul. 23, 2026

(54) MODULAR CONCEPT-BASED LANGUAGE PROCESSING WITH TRACE-DRIVEN RESOURCE TIERING AND DYNAMIC CACHING

(71) Applicant: Leon Rivkin, Old Brookville, NY (US)

(72) Inventor: Leon Rivkin, Old Brookville, NY (US)

(21) Appl. No.: 19/452,776

(22) Filed: Jan. 19, 2026

Related U.S. Application Data
(60) Provisional application No. 63/747,039, filed on Jan. 19, 2025.

(51) Int. Cl. G06F 12/0862; G06F 18/21; G06F 18/2131; G06F 18/22; G06F 40/30; G06N 3/044; G06N 3/048

(52) U.S. Cl. CPC G06F 12/0862; G06F 18/2131; G06F 18/217; G06F 18/22; G06F 40/30; G06N 3/044; G06N 3/048

(57) ABSTRACT

Modular systems and methods for concept-based processing of natural language are provided. An ontology dictionary stores concepts each having a concept identifier, attributes, and typed relationships. Natural language inputs are mapped to concept identifiers, optionally by deriving intermediate units using transforms or statistical analysis and mapping the intermediate units to concepts, or by mapping raw tokens to concepts. A neural network model processes the concept identifiers to generate outputs. During inference and/or training, a trace engine records activation information associated with concepts and stores activation information or derived statistics in a trace data structure. A resource controller uses the trace data structure to reconfigure, during inference for subsequent inputs, a resource allocation policy that allocates frequently used concept data to a faster memory tier and allocates infrequently used concept data to a slower tier or specialized tail handling. Predictive prefetching and relational group caching may be performed.

### CROSS-REFERENCE TO RELATED APPLICATIONS

This application claims the benefit of priority under 35 U.S.C. § 119(e) to U.S. Provisional Patent Application No. 63/747,039, filed on Jan. 19, 2025, entitled “Modular Concept-Based Language Modeling with Synergistic Integration of Compression, Ontology, Trace Logging, and Caching,” the entire disclosure of which is hereby incorporated by reference in its entirety for all purposes.

The present application is related to additional applications that may be filed from the same portfolio concerning concept dictionaries, typed relationships, activation tracing, and dynamic caching and tiering for neural inference and training. The disclosures of such related applications, to the extent they exist and to the extent not inconsistent herewith, are hereby incorporated by reference for all purposes.

### STATEMENT REGARDING FEDERALLY SPONSORED RESEARCH OR DEVELOPMENT

The subject matter described herein was not made under, and is not subject to, any contract, grant, or award with any agency of the United States Government.

### BACKGROUND OF THE DISCLOSURE

### Field of the Disclosure

The present disclosure relates generally to artificial intelligence, machine learning, and natural language processing.

More particularly, the disclosure relates to modular methods and systems for processing natural language content in which: (i) input content is mapped to stable concept identifiers in an ontology dictionary having typed relationships; (ii) a neural model processes the concept identifiers; (iii) activation information is recorded in a trace data structure during inference and/or training; and (iv) the trace data structure is used to dynamically adjust resource allocation policies including multi-tier caching and optional specialized handling for infrequently used concepts.

In certain embodiments, the disclosure provides an architecture-neutral framework in which compressible intermediate representations may be used to generate intermediate units (including micro-concepts) for mapping to a concept dictionary, or in which raw tokens are mapped directly to concepts, without altering the fundamental trace-driven resource allocation loop.

### Description of Related Art

### Token-Based Neural Language Models

Modern language models typically operate on tokenized sequences and perform inference by applying repeated attention and feedforward computations across many layers. Such models can provide high quality outputs but often exhibit substantial computational cost, high memory footprint, and latency challenges, particularly for long-context inputs or high-throughput deployments. In addition, token-based execution often provides limited transparency regarding which internal concepts or relationships contributed to outputs.

### Ontology- and Knowledge-Graph-Enhanced Approaches

Ontology-based and knowledge-graph-driven approaches have been developed to improve consistency and interpretability by grounding text to structured concepts and typed relationships. Such approaches can provide structured knowledge, but frequently require brittle mapping and may not provide a practical closed-loop mechanism for continuously adapting runtime resource allocation based on observed activation behavior during inference.

### Compression and Intermediate Representations

Various compression approaches have been proposed to reduce input size and computational cost, including subword tokenization, hashing, vector quantization, clustering, and signal-processing transforms. While compression may reduce sequence length, many approaches do not preserve stable concept identity across time and domains, and many do not connect compressed representations to a persistent concept dictionary that is used as a primary unit of processing and resource allocation.

### Neural Trace Logging and Interpretability Tools

A variety of logging and interpretability methods have been developed to record or visualize internal activations, including attention visualization and attribution analysis. Such tools can provide post-hoc insight but often function as external analysis mechanisms and do not provide mechanisms for using recorded activations to dynamically adjust runtime caching, memory tiering, routing, or concept handling in subsequent inference cycles.

### Caching, Memory Management, and Adaptive Inference

Caching is commonly used to improve performance by storing frequently used data in faster memory tiers and evicting or offloading less frequently used data. Typical cache policies include least-recently used and frequency-based policies, and some systems employ predictive prefetching. However, caching approaches are often implemented without stable concept identifiers and without concept-normalized trace evidence derived from neural model execution. As a result, caching may not be optimized for concept-level neural workloads and may not adapt robustly to changes in concept usage over time.

### Limitations of Prior Art

Broadly, prior approaches can be grouped into categories including token-based neural language models, ontology-enhanced models, compression-based intermediate representation systems, interpretability and logging systems, and caching and memory management systems. These approaches typically treat mapping, logging, and caching as separate concerns and do not implement a unified modular closed-loop architecture that uses concept-normalized trace information to dynamically adjust resource allocation during inference and/or training.

Prior systems do not disclose a practical integrated system in which natural language inputs are mapped to concept identifiers in an ontology dictionary; a neural model processes the concept identifiers; a trace data structure records concept-associated activation information during inference and/or training; and the trace data structure is used to dynamically adjust a resource allocation policy during inference for subsequent inputs, including promoting frequently used concept data to faster-access storage while demoting infrequently used concept data to slower storage or specialized handling, optionally including predictive prefetching and relational group caching based on co-activation patterns.

There remains a need for systems and methods that reduce computational cost and memory footprint for concept-based language processing; that preserve stable concept identity via an ontology dictionary; that provide trace-driven reconfiguration of resource allocation policies for subsequent inference cycles; and that support closed-loop adaptation in which trace-derived usage patterns inform mapping, caching, and concept handling decisions over time. The present disclosure addresses these needs.

### SUMMARY OF THE DISCLOSURE

It is an object of the present disclosure to provide modular methods and systems for processing natural language content using stable concept identifiers organized in an ontology dictionary.

It is a further object of the disclosure to provide a trace data structure that records activation information during inference and/or training of neural models to provide a compact, concept-normalized representation of model usage behavior.

It is another object of the disclosure to provide trace-driven resource allocation policies that improve latency and memory footprint by promoting frequently used concept data to faster-access memory tiers and demoting infrequently used concept data to slower tiers.

It is an additional object of the disclosure to provide specialized handling for infrequently used concepts, including on-demand activation of a specialized submodel responsive to detecting tail concepts.

It is also an object of the disclosure to provide closed-loop adaptation in which trace-derived usage patterns are used to update caching policies, thresholds, and optionally the ontology dictionary for subsequent inputs.

These and other objects are achieved by modular systems and methods that couple: (i) concept mapping using an ontology dictionary; (ii) neural processing using concept identifiers and optional typed relationship information; (iii) trace capture of activation information during execution; and (iv) dynamic tiering, caching, and tail concept handling based on trace-derived statistics, including reconfiguration during inference for subsequent inputs.

In one aspect, the disclosure provides a computer-implemented method for concept-based language processing comprising: providing an ontology dictionary that organizes a plurality of concepts, each concept having at least (i) a unique identifier, (ii) one or more attributes, and (iii) typed relationships to other concepts; receiving an input data sequence associated with natural language; mapping at least a portion of the input data sequence to a sequence of concept identifiers associated with the ontology dictionary; processing the sequence of concept identifiers using a neural network model; recording activation information associated with at least a subset of the concepts in a trace data structure during inference and/or training; and dynamically adjusting, during inference for subsequent inputs, based on the activation information, a resource allocation policy that allocates frequently used concept data to a first memory tier and allocates infrequently used concept data to at least one of a second memory tier and specialized handling.

In another aspect, the disclosure provides a system comprising: a memory storing an ontology dictionary comprising a plurality of concepts each associated with at least a concept identifier, one or more attributes, and typed relationships; a concept mapping module configured to map natural language inputs to concept identifiers; a neural network model configured to process concept identifiers; a trace engine configured to record activation information during inference and/or training and store the activation information in a trace data structure; and a resource controller configured to dynamically adjust a resource allocation policy based on the activation information, including allocating concept data to a faster-access tier or a slower-access tier and optionally enabling specialized handling for tail concepts.

In a further aspect, the disclosure provides a non-transitory computer-readable medium storing instructions that, when executed by one or more processors, cause the one or more processors to perform operations corresponding to the foregoing methods.

In various embodiments, mapping comprises at least one of: (a) deriving intermediate units corresponding to recurring patterns or features in the input data sequence using at least one transform or statistical analysis and mapping the intermediate units to concepts; and (b) mapping raw tokens to concepts without deriving intermediate units. In certain embodiments, mapping produces confidence scores, and low-confidence mappings are flagged for re-analysis or fallback.

In various embodiments, the trace data structure stores usage statistics and co-activation statistics for concept identifiers, and the resource allocation policy uses such statistics to perform at least one of promotion, demotion, eviction, predictive prefetching, and relational group caching. In various embodiments, head/tail thresholds are dynamically tuned based on observed activation frequencies and performance metrics. In various embodiments, the ontology dictionary is updated based on trace-derived statistics and used for mapping subsequent input data sequences to form a feedback loop.

Additional aspects, embodiments, and variations will be apparent from the detailed description, drawings, and claims that follow.

### BRIEF DESCRIPTION OF THE DRAWINGS

FIG. 1 is a schematic top-level view of a modular concept-based processing system according to the disclosure, showing a concept mapping module, an ontology dictionary, a neural model, a trace engine, and a resource controller;

FIG. 2 is a block diagram illustrating an end-to-end flow from natural language input through concept mapping, neural processing, trace capture, and trace-driven resource allocation;

FIG. 3 is a schematic representation of an ontology dictionary storing concept identifiers, attributes, and typed relationships, and further showing representative indexing structures for concept lookup;

FIG. 4 is a schematic representation of a trace data structure storing concept-associated activation information and usage statistics, including time-windowed summaries and long-term summaries;

FIG. 5 is a schematic representation of a multi-tier concept data store, illustrating promotion and demotion of concept data between a faster-access tier and a slower-access tier;

FIG. 6 is a schematic representation of tail concept handling, illustrating on-demand activation of a specialized submodel responsive to detecting a tail concept;

FIG. 7 is a flowchart illustrating a trace-driven control loop that adjusts head/tail thresholds and caching policies during inference based on trace-derived activation frequencies and performance metrics;

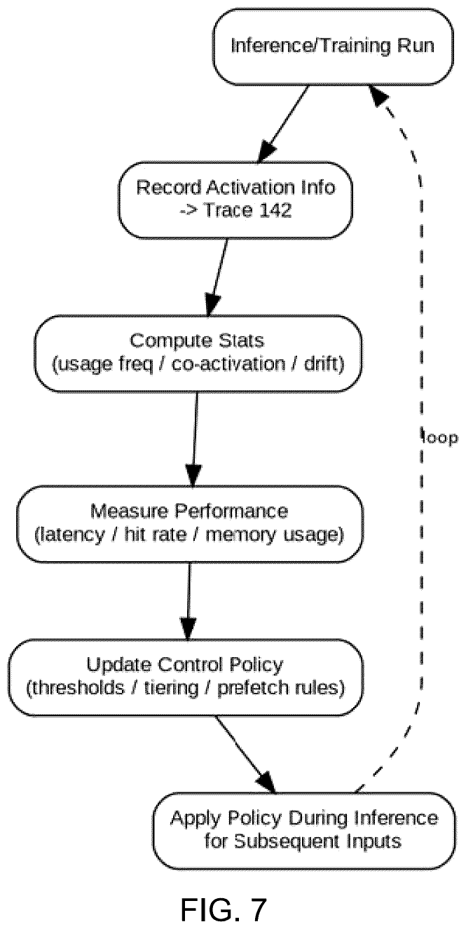

FIG. 8 is a schematic representation of relational group caching and predictive prefetching based on co-activation patterns recorded in the trace data structure;

FIG. 9 is a flowchart illustrating optional ontology updates based on trace-derived co-activation statistics and use of the updated ontology for mapping subsequent inputs; and

FIG. 10 is a schematic illustration of alternative embodiments and deployment configurations, including distributed trace capture and multi-tier concept storage.

The drawings are schematic in nature and are not necessarily to scale. Certain dimensions may be exaggerated for purposes of illustration, and similar reference numerals in different figures may denote similar or corresponding elements for convenience of description.

### DETAILED DESCRIPTION OF THE DRAWINGS

### System Overview

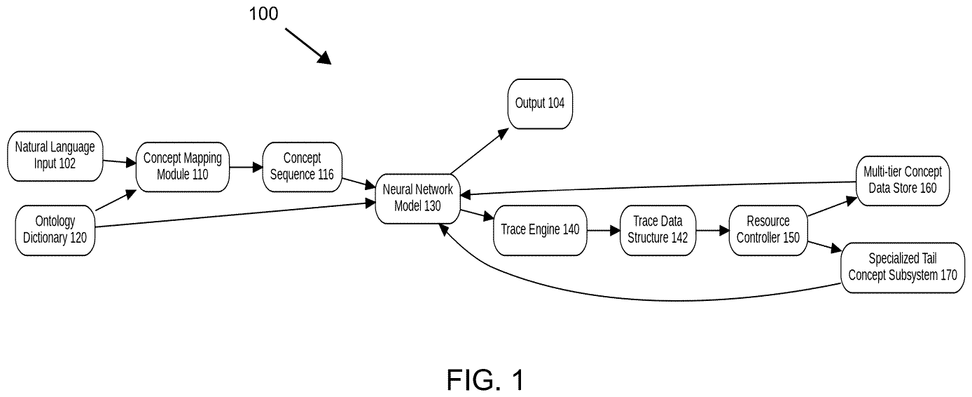

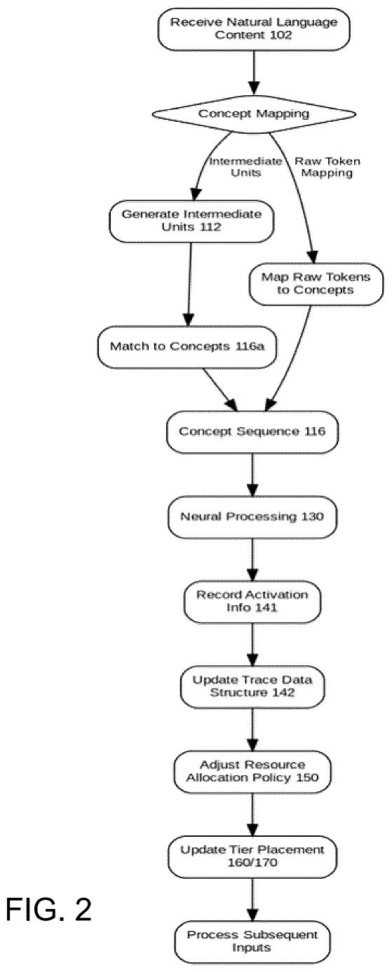

Referring to FIGS. 1-2, a modular concept-based processing system 100 is provided for processing natural language content 102 to produce an output 104. In embodiments, the system 100 comprises a concept mapping module 110, an ontology dictionary 120, a neural network model 130, a trace engine 140, and a resource controller 150 operatively coupled to a multi-tier concept data store 160. In further embodiments, the system 100 optionally comprises a specialized tail concept subsystem 170 for handling infrequently used concepts.

In embodiments, the system 100 implements a closed-loop architecture in which: (a) input content is mapped to stable concept identifiers; (b) the concept identifiers are processed by the neural network model 130; (c) activation information associated with one or more concepts is recorded by the trace engine 140 during inference and/or training; and (d) the resource controller 150 dynamically adjusts resource allocation policies during inference for subsequent inputs based on the recorded activation information.

### Definitions and Terminology

As used herein, “concept” refers to a normalized semantic unit stored in the ontology dictionary 120, and “concept identifier” refers to a unique identifier associated with a concept record in the ontology dictionary 120.

As used herein, “ontology dictionary” refers to a structured data store organizing concepts and typed relationships between concepts, optionally including attributes, indices, and vector representations.

As used herein, “typed relationship” refers to a relationship stored between concepts having an associated relationship type (e.g., is-a, part-of, belongs-to, enables, located in, derived from, related-to). In embodiments, typed relationships are stored as edges in a graph structure.

As used herein, “activation information” refers to any data produced during inference and/or training of the neural network model 130 that indicates usage, relevance, contribution, or participation of one or more concepts or relationships, including by way of example attention weights, embedding activation magnitudes, and relationship usage counts.

As used herein, “trace data structure” refers to a data structure that stores at least a portion of activation information and/or statistics derived therefrom, including by way of example a dense matrix, sparse matrix, tensor, sparse graph, hierarchical log structure, or distributed log structure.

As used herein, “resource allocation policy” refers to a policy controlling allocation of at least one computational or memory resource to concept data and/or model components, including tier placement, caching, promotion, demotion, eviction, prefetching, routing, and on-demand activation of specialized handling.

As used herein, “memory tier” refers to a storage class characterized by at least one of latency, bandwidth, or capacity. In representative embodiments, a first memory tier includes on-chip memory, SRAM, HBM, or VRAM; a second memory tier includes DRAM; and a base storage tier includes SSD or network storage. These examples are illustrative and not limiting.

As used herein, “head concept” refers to a concept designated as frequently used according to a frequency measure, and “tail concept” refers to a concept designated as infrequently used according to the frequency measure and/or a dynamic threshold.

### High-Level Operational Flow

Referring to FIG. 2, in embodiments the system 100 performs operations including:
(a) receiving natural language content 102;
(b) mapping at least a portion of the content 102 to concept identifiers using concept mapping module 110 and ontology dictionary 120 to form a concept sequence 116;
(c) processing the concept sequence 116 using the neural network model 130 to produce at least one output 104;
(d) recording activation information associated with one or more concepts and/or relationships during inference and/or training using trace engine 140, and storing the activation information in trace data structure 142;
(e) updating usage statistics 144 and, in some embodiments, co-activation statistics 146 based on the activation information; and
(f) dynamically adjusting, during inference for subsequent inputs and/or subsequent inference cycles, a resource allocation policy using resource controller 150 to control multi-tier concept storage 160 and, in some embodiments, specialized tail concept handling 170.

### Technical Advantages and Computer System Improvements

In embodiments, the system 100 provides one or more technical advantages and improvements to computer system operation, including:
(a) reducing memory footprint in fast memory tiers by storing only selected concept data in the first memory tier 162 while maintaining a larger ontology dictionary 120 in a base storage tier;
(b) reducing cache miss rate by promoting frequently used concept data to the first memory tier 162 and by caching related concept neighborhoods;
(c) improving latency for typical inputs by reducing load and fetch operations for tail concept data while preserving access to tail capability via specialized handling 170; and
(d) improving adaptability by dynamically tuning head/tail thresholds based on observed activation frequencies and performance metrics.

In embodiments, the foregoing improvements are achieved by a closed-loop mechanism in which activation information captured during inference and/or training is stored in the trace data structure 142 and used to reconfigure a resource allocation policy during inference for subsequent inputs. In embodiments, the resource allocation policy performs at least one of promotion, demotion, eviction, and predictive prefetching of concept data across memory tiers, and optionally enables specialized handling for infrequently used concepts. In embodiments, relational group caching reduces cache misses by co-locating concept data for concepts that are frequently co-activated, thereby reducing repeated fetch operations and improving effective memory locality for concept neighborhoods.

These improvements may be realized without requiring any particular neural network architecture, transform family, ontology source, or deployment configuration, and do not alter the fundamental modular closed-loop architecture described herein.

### Ontology Dictionary

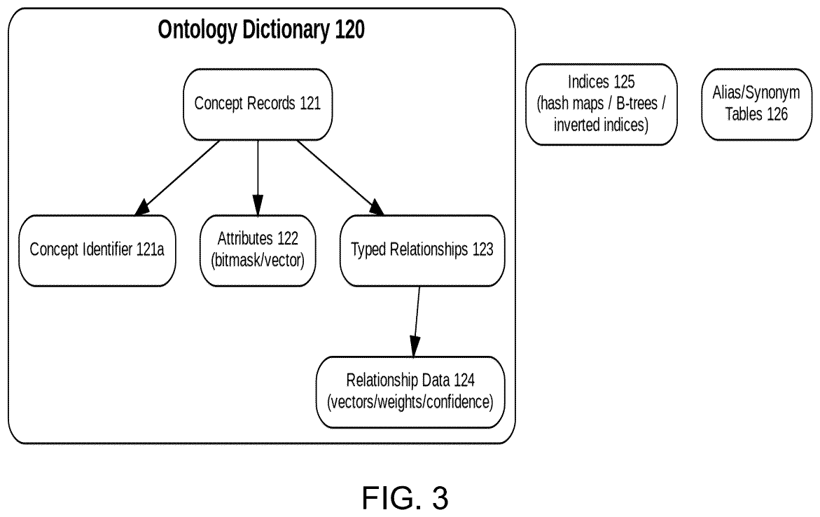

Referring to FIG. 3, the ontology dictionary 120 comprises a plurality of concept records 121. In embodiments, each concept record 121 includes: a concept identifier 121a; one or more attributes 122; and one or more typed relationships 123 linking the concept to other concepts.

In embodiments, the one or more attributes 122 comprise an attribute vector and/or a bitmask encoding at least one concept category. In embodiments, the ontology dictionary 120 further stores relationship data 124, including relationship vectors or relationship embeddings derived from typed relationships 123, and optionally includes relationship weights and/or confidence values.

In embodiments, the ontology dictionary 120 includes one or more indices 125 to support concept lookup, including by way of example hash maps, B-tree indices, and inverted indices. In embodiments, the ontology dictionary 120 further includes alias tables 126, synonym tables, and/or canonicalization tables to support mapping.

### Typed Relationships

In embodiments, typed relationships 123 include hierarchical and associative relationships such as is-a, part-of, belongs-to, enables, located in, derived from, and related-to. In some embodiments, relationship weights and/or confidence values are updated over time based on trace-derived statistics as described below.

### Concept Mapping Module

Referring to FIGS. 1-2, the concept mapping module 110 receives natural language content 102 and produces concept identifiers in a concept sequence 116. In embodiments, mapping comprises at least one of:
(a) deriving intermediate units 112 (including micro-concepts) corresponding to recurring patterns or features in the input data sequence using at least one transform or statistical analysis and mapping the intermediate units to concepts 116a in the ontology dictionary 120; or
(b) mapping raw tokens of the input directly to concepts in the ontology dictionary 120 without deriving intermediate units.

In embodiments, (a) and (b) may be applied to different portions of the same input sequence.

### Transform-Based Intermediate Units

In embodiments, deriving intermediate units comprises applying at least one transform to text or to representations derived from text. In representative embodiments, the transform includes wavelet transforms. In some embodiments, the wavelet transform is selected from Haar, Daubechies, and Symlets wavelets.

### Statistical Intermediate Units

In additional or alternative embodiments, deriving intermediate units comprises applying statistical analysis. In representative embodiments, statistical analysis includes at least one of co-occurrence matrices, n-grams, clustering, density-based methods, and pattern-recognition methods. In some embodiments, intermediate units are represented by one or more of a centroid vector, a prototype pattern, or a hash code.

### Similarity Matching, Confidence, and Fallback

In embodiments, mapping intermediate units and/or raw tokens to concepts comprises comparing a representation of an input unit to a representation associated with a concept record using a similarity measure, and selecting a concept identifier based on the similarity measure. In embodiments, mapping produces confidence scores, and units having confidence below a threshold are flagged for re-analysis or routed to a fallback mapping method.

In embodiments, fallback mapping includes one or more of: expanding the candidate set of concepts; applying alternate normalization; applying a disambiguation routine; or preserving an unmapped unit for subsequent handling.

In embodiments, a small neural network (e.g., feedforward or recurrent) is used to refine ambiguous mappings by producing a revised confidence score and/or selecting between candidate concept identifiers.

### Neural Network Model

Referring to FIG. 1, the neural network model 130 processes concept identifiers in concept sequence 116 to generate output 104. In embodiments, the neural network model 130 includes at least one embedding mechanism for representing concept identifiers and at least one processing mechanism for combining information across the concept sequence. In embodiments, the neural network model 130 comprises a transformer-like architecture, a recurrent architecture, or other neural architecture.

### Relationship Integration

In embodiments, processing integrates typed relationship information derived from the ontology dictionary 120 into at least one of an attention mechanism, a gating mechanism, or an embedding mechanism. Such integration may include, by way of example, adding relationship vectors, constraining attention between concept identifiers based on relationship type, biasing a gating function based on relationship type, or augmenting embeddings with relationship-derived features. These embodiments are optional and do not alter the fundamental closed-loop architecture.

### Trace Engine and Trace Data Structure

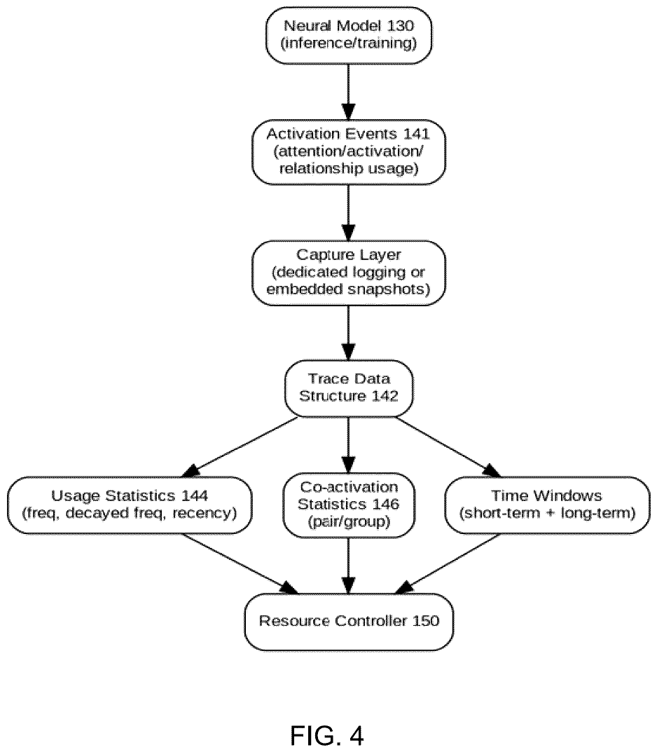

Referring to FIG. 4, the trace engine 140 records activation information 141 during inference and/or training and stores activation information and/or derived statistics in trace data structure 142. In embodiments, the trace data structure 142 stores usage statistics 144 for concept identifiers, and in further embodiments stores co-activation statistics 146 for pairs or groups of concept identifiers.

In embodiments, activation information 141 is derived from at least one of: attention weights, embedding activation magnitudes, and relationship usage counts. In embodiments, the trace data structure is configured to store data indicating usage or relevance of concepts or features during inference.

### Recording Mechanisms

In embodiments, recording is performed by a dedicated logging function that captures activation information from forward passes. In additional or alternative embodiments, recording is embedded within intermediate model tensors or intermediate layers by periodically extracting activation snapshots. In embodiments, separate partial traces may be recorded for different layers or segments and merged post-inference.

### Time Windows and Aggregation

In embodiments, usage statistics are computed over one or more time windows, including short-term windows and long-term windows, and may include time-decayed values and/or recency-weighted values. In embodiments, the trace data structure stores aggregated statistics derived from multiple inference calls to support historical trend detection, anomaly detection, and co-activation analysis.

### Resource Controller and Multi-Tier Concept Data Store

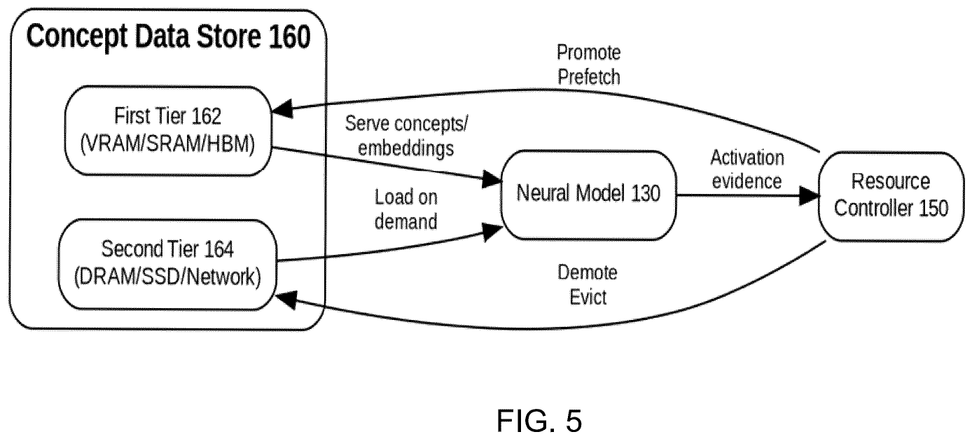

Referring to FIG. 5, the resource controller 150 dynamically adjusts a resource allocation policy based on the trace data structure 142. In embodiments, the resource allocation policy allocates frequently used concept data to a first memory tier 162 and allocates infrequently used concept data to at least one of a second memory tier 164 and specialized handling 170. In embodiments, a base storage tier stores at least a portion of the ontology dictionary and/or tail model parameters 172.

In embodiments, the resource controller 150 performs promotion, demotion, eviction, and predictive prefetching of concept data across tiers, and may tune one or more thresholds based on performance metrics including latency, cache hit rate, and memory usage.

In embodiments, usage frequency is determined from activation information recorded in the trace data structure and/or from usage statistics determined by frequency counters associated with cached data.

### Head/Tail Threshold Control and Hysteresis

In embodiments, the resource controller designates a concept as a tail concept when an activation frequency drops below a dynamic threshold, and promotes a concept to a head concept when activation frequency exceeds a higher threshold. In embodiments, the activation frequency is computed over at least one time window derived from the trace data structure, thereby implementing hysteresis behavior using distinct promote/demote thresholds.

In embodiments, the dynamic threshold is updated in real time and/or by periodically analyzing recent trace logs, and is tuned based on at least one performance metric.

### Predictive Prefetching

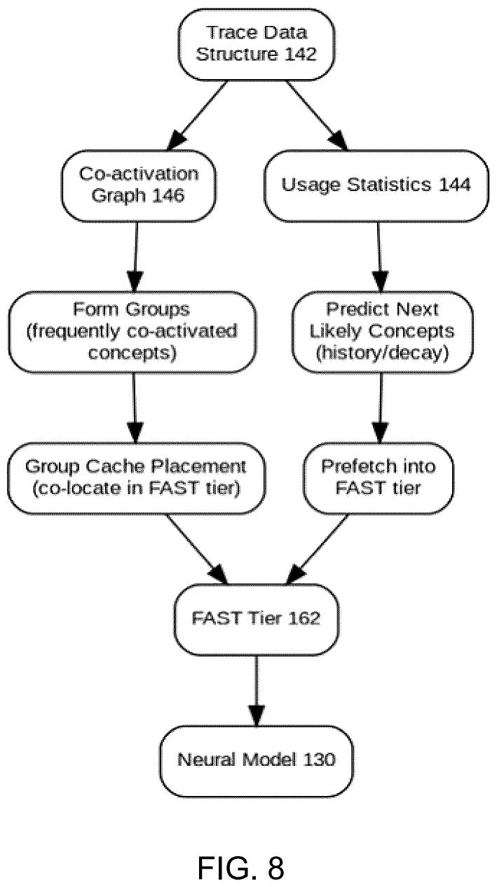

Referring to FIG. 8, in embodiments the resource controller performs predictive prefetching of concept data into the first memory tier 162 based on historical usage patterns derived from the trace data structure.

### Relational Group Caching

Referring to FIG. 8, in embodiments the resource controller performs relational group caching by caching, with a head concept, one or more concepts frequently co-activated with the head concept. In embodiments, group membership is determined using co-activation statistics.

### Specialized Tail Concept Handling

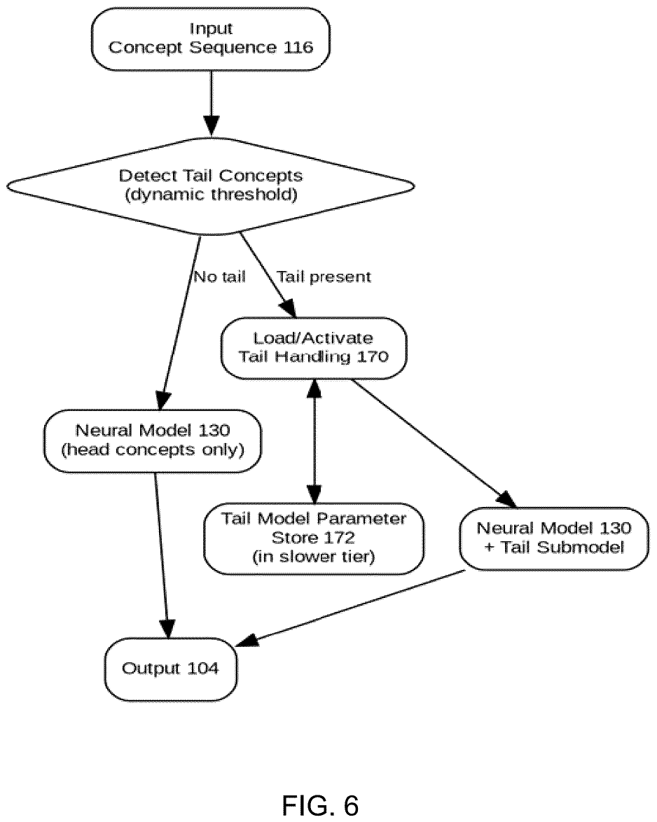

Referring to FIG. 6, in embodiments specialized handling 170 comprises loading or activating a specialized submodel trained on infrequently used concepts responsive to encountering a tail concept identifier during mapping. In embodiments, specialized handling reduces overhead for typical inputs while retaining capability for rare tail concepts.

### Cache Entry Structure

In embodiments, the first memory tier stores, for each cached concept, a cache entry comprising at least: (i) a concept identifier and (ii) concept data comprising at least one of an embedding, a relationship vector, an attribute bitmask, or metadata for the cached concept. In embodiments, cache entries optionally include frequency counters and/or timestamps used to compute usage frequency.

### Ontology Updates and Closed-Loop Operation

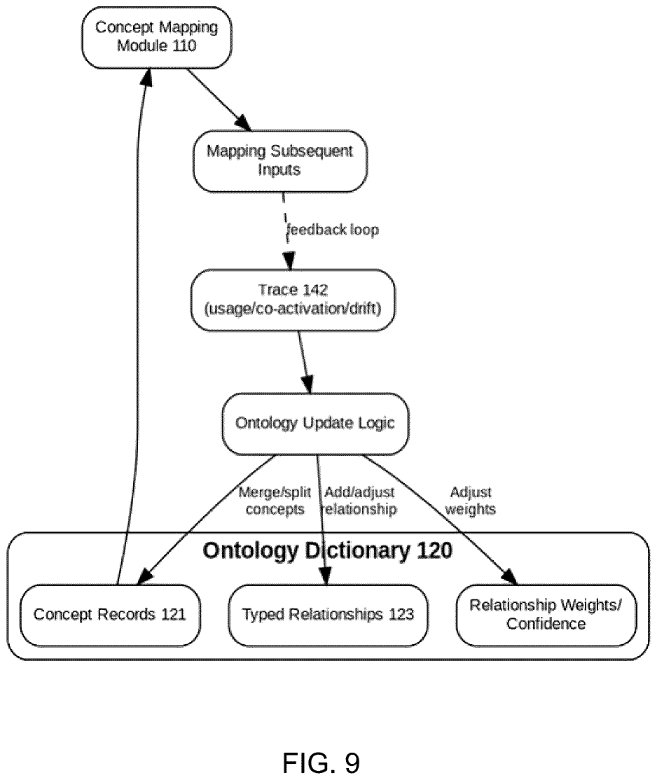

Referring to FIG. 9, in embodiments the ontology dictionary 120 is updated based on trace-derived statistics, including co-activation frequencies and indications of semantic drift. In embodiments, updates include at least one of: adding relationships, adjusting relationship weights, merging concepts, and splitting concepts.

In embodiments, the updated ontology dictionary is used for mapping subsequent input data sequences, thereby forming a feedback loop that progressively improves mapping quality and resource allocation efficiency over time.

### Distributed and Alternative Deployment Configurations

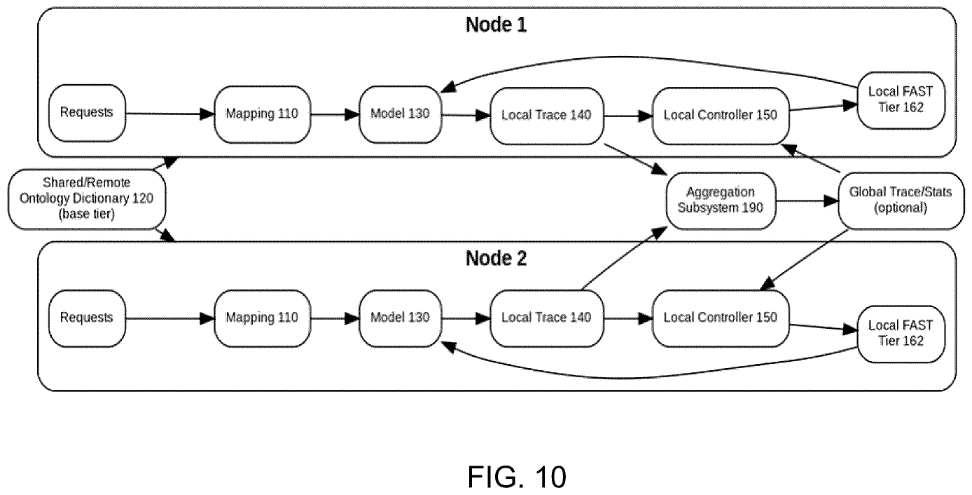

Referring to FIG. 10, in embodiments the system 100 is deployed in a distributed configuration in which concept data is partitioned across multiple nodes. In embodiments, trace data is captured locally and aggregated by an aggregation subsystem 190. In such embodiments, aggregated trace-derived statistics may be used to update resource allocation policies across nodes.

Numerous modifications and alternative embodiments will be apparent to those of ordinary skill in the art. The choice of deployment configuration does not alter the fundamental modular closed-loop architecture described herein.

What is claimed is:

1. A method for concept-based language processing, the method comprising:
providing an ontology dictionary that organizes a plurality of concepts, each concept having at least (i) a unique identifier, (ii) one or more attributes, and (iii) a set of typed relationships to other concepts;
receiving an input data sequence associated with natural language;
mapping at least a portion of the input data sequence to a sequence of concept identifiers associated with the ontology dictionary;
processing the sequence of concept identifiers using a neural network model;
recording, during inference and/or training of the neural network model, activation information associated with at least a subset of the concepts in a trace data structure; and
dynamically adjusting, during inference for subsequent inputs, based on the activation information, a resource allocation policy that allocates data associated with frequently used concepts to a first memory tier and allocates data associated with infrequently used concepts to at least one of a second memory tier and a specialized submodel configured to handle infrequently used concepts.

2. The method of claim 1, wherein the one or more attributes comprise a bitmask encoding one or more categories of a concept.

3. The method of claim 1, wherein the typed relationships include relationships selected from the group consisting of: is-a, part-of, enables, belongs-to, located in, derived from, and related-to.

4. The method of claim 1, wherein mapping comprises one or more of:
(a) deriving intermediate units corresponding to recurring patterns or features in the input data sequence using at least one transform or statistical analysis, and mapping the intermediate units to the concepts; and
(b) mapping raw tokens of the input data sequence to the concepts without deriving intermediate units;
wherein (a) and (b) may be applied to different portions of the input data sequence.

5. The method of claim 4, wherein the at least one transform comprises a wavelet transform.

6. The method of claim 5, wherein the wavelet transform is selected from the group consisting of Daubechies, Haar, and Symlets wavelets.

7. The method of claim 4, wherein the statistical analysis comprises at least one of co-occurrence matrices, n-grams, clustering, density-based methods, or pattern-recognition methods.

8. The method of claim 4, wherein each intermediate unit is represented by at least one of a centroid vector, a prototype pattern, or a hash code.

9. The method of claim 1, wherein mapping comprises comparing a vector representation of an intermediate unit to a vector representation associated with a concept in the ontology dictionary using a similarity measure.

10. The method of claim 9, wherein mapping further comprises using a small feedforward or recurrent network to refine mappings for ambiguous cases.

11. The method of claim 1, wherein mapping produces confidence scores, and wherein intermediate units having confidence scores below a threshold are flagged for re-analysis or for a fallback mapping method.

12. The method of claim 1, wherein the neural network model comprises at least one of a transformer-like architecture, a recurrent architecture, or another neural network architecture.

13. The method of claim 1, wherein processing comprises integrating typed relationship information derived from the ontology dictionary into at least one of an attention mechanism, a gating mechanism, or an embedding mechanism of the neural network model.

14. The method of claim 1, wherein the trace data structure comprises at least one of a dense matrix, a sparse matrix, a tensor, a sparse graph, a distributed log structure, or a hierarchical log structure.

15. The method of claim 1, wherein the activation information is derived from at least one of: attention weights in neural layers, embedding activation magnitudes, relationship usage counts, or other statistical or learned measures.

16. The method of claim 1, wherein the trace data structure is configured to store data indicating usage or relevance of concepts or features during inference.

17. The method of claim 1, wherein recording comprises at least one of:
(a) capturing activation information from each forward pass using a dedicated logging function;
(b) embedded recording within existing model tensors or intermediate layers by periodically extracting activation snapshots; or
(c) storing separate partial traces for different layers or segments of the neural network model and merging said partial traces post-inference.

18. The method of claim 1, further comprising analyzing the trace data structure to determine usage patterns including at least one of identifying spikes in concept usage, detecting anomalies, aggregating entries over multiple queries to detect historical trends, or identifying co-activation frequencies for concepts that are activated together.

19. The method of claim 1, wherein dynamically adjusting comprises reconfiguration of at least one of caching policies, promotion, demotion, or eviction of concept data across memory tiers, or routing of inputs to specialized handling.

20. The method of claim 1, wherein dynamically adjusting comprises an adaptive thresholding policy in which:
(a) a concept is designated as a tail concept when an activation frequency drops below a dynamic threshold;
(b) a concept is promoted to a head concept when activation frequency exceeds a higher threshold; and
(c) the dynamic threshold is tuned based on at least one performance metric selected from latency, cache hit rate, or memory usage, and is updated in real time and/or by periodically analyzing recent trace logs.

21. The method of claim 1, wherein dynamically adjusting comprises predictive prefetching of concept data into the first memory tier based on historical usage patterns.

22. The method of claim 1, wherein dynamically adjusting comprises relational group caching in which concepts frequently co-activated with a head concept are cached together in the first memory tier.

23. The method of claim 1, wherein the first memory tier stores, for each cached concept, a cache entry comprising: (i) a concept identifier, and (ii) concept data comprising at least one of an embedding, a relationship vector, an attribute bitmask, or metadata for the cached concept.

24. The method of claim 20, wherein the activation frequency is computed over at least one time window derived from the trace data structure, and wherein promotion to head occurs when the activation frequency exceeds the higher threshold and designation as tail occurs when the activation frequency drops below the dynamic threshold.

25. A system for concept-based language processing, comprising:
a memory storing an ontology dictionary that organizes a plurality of concepts, each concept having at least (i) a unique identifier, (ii) one or more attributes, and (iii) a set of typed relationships to other concepts;
a processor configured to:
receive an input data sequence associated with natural language;
map at least a portion of the input data sequence to concept identifiers associated with the ontology dictionary;
process the concept identifiers using a neural network model;
record activation information during inference and/or training in a trace data structure; and
dynamically adjust, during inference for subsequent inputs, a resource allocation policy based on the activation information,
wherein frequently used concepts are allocated to a first memory tier and infrequently used concepts are allocated to at least one of a second memory tier and a specialized submodel.

26. The system of claim 25, wherein the first memory tier is selected from the group consisting of VRAM and SRAM, and the second memory tier is selected from the group consisting of DRAM and SSD, and wherein the system optionally includes a multi-level hierarchy comprising additional cache tiers.

27. The system of claim 25, wherein the specialized submodel comprises a smaller neural network trained on infrequently used concepts and is loaded or activated on-demand responsive to encountering a tail concept.

28. The system of claim 25, wherein the resource allocation policy determines a usage frequency for concepts based on activation information recorded in the trace data structure and/or based on usage statistics determined by frequency counters.

29. The system of claim 25, wherein the ontology dictionary is dynamically updated based on usage analysis, including merging or splitting concepts when trace data indicates overlapping usage or semantic drift, and wherein the updated ontology dictionary is used for mapping subsequent input data sequences.

30. A non-transitory computer-readable medium storing instructions that, when executed by one or more processors, cause the one or more processors to perform the method of claim 1.
